(19) United States
(12) Patent Application Publication
(10) Pub. No.: US 2013/0216700 A1
(43) Pub. Date: Aug. 22, 2013

(54) MANUFACTURING METHOD OF ELECTRODE CATALYST LAYER

(71) Applicant: Toppan Printing Co., Ltd., (US)

(72) Inventors: Hiroyuki Morioka, Tokyo (JP); Haruna Kurata, Tokyo (JP); Saori Okada, Tokyo (JP); Kenichiro Oota, Kanagawa (JP)

(73) Assignee: Toppan Printing Co., Ltd., Tokyo (JP)

(21) Appl. No.: 13/850,897

(22) Filed: Mar. 26, 2013

Related U.S. Application Data
(63) Continuation of application No. PCT/JP2011/071481, filed on Sep. 21, 2011.

(30) Foreign Application Priority Data
Sep. 28, 2010 (JP) 2010-217814

(51) Int. Cl. H01M 4/88

(52) U.S. Cl. CPC H01M 4/8828
USPC 427/115

(57) ABSTRACT

The invention includes a manufacturing method of an electrode catalyst layer which contains a polymer electrolyte, a catalyst and carbon particles and achieves a high power generation performance even when an oxide of non-platinum is used as the catalyst. The method has a feature of including either a process of preliminarily embedding the catalyst in the polymer electrolyte or a process of preliminarily embedding the carbon particles in the polymer electrolyte.

This application is a continuation of International Application No. PCT/JP2011/071481, filed Sep. 21, 2011, which is incorporated herein by reference in its entirety.

### BACKGROUND OF THE INVENTION

1. Field of the Invention

The present invention relates to a manufacturing method of an electrode catalyst layer, a membrane electrode assembly (MEA) and a PEFC (polymer electrolyte fuel cell) or PEMFC (proton exchange membrane fuel cell) which include the electrode catalyst layer. More specifically, the present invention relates to a manufacturing method of an electrode catalyst layer which uses a non-platinum catalyst (non-precious metal catalyst) and achieves a high level of power generation performance, as well as an MEA and a PEFC (or PEMFC) which include the electrode catalyst layer.

2. Description of the Related Art

A fuel cell is a power generation system which produces electric power along with heat. In a fuel cell, a fuel gas including hydrogen and an oxidant gas including oxygen react together at electrodes containing a catalyst so that a reverse reaction of water electrolysis takes place. A fuel cell is attracting attention as a clean energy source of the future because of advantages such as high efficiency, a small impact on the environment and a low level of noise relative to conventional power generation systems. A fuel cell is classified into several types according to an ion conductor employed therein. A fuel cell which uses a proton-conductive polymer membrane is called a polymer electrolyte fuel cell (PEFC) or a proton exchange membrane fuel cell (PEMFC).

Among various fuel cells, a PEFC (or PEMFC), which can be used at around room temperature, is regarded as a promising fuel cell for use in vehicles and household stationary power supply etc. and has been developed widely in recent years. In the PEFC (or PEMFC), a joint unit which has a pair of electrode catalyst layers on both sides of a polymer electrolyte membrane (PEM) and is called a membrane electrode assembly (Membrane and Electrode Assembly, hereinafter also referred to as MEA) is arranged between a pair of separators, on each of which either a gas flow path for supplying a fuel gas including hydrogen to one of the electrodes or a gas flow path for supplying an oxidant gas including oxygen to the other electrode is formed. The electrode for supplying a fuel gas is called a fuel electrode or anode whereas the electrode for supplying an oxidant gas is called an air electrode or cathode. In general, each of these electrodes includes an electrode catalyst layer, in which a polymer electrolyte(s) and catalyst loaded carbon particles are stacked, and a gas diffusion layer which has gas permeability and electron conductivity. A noble metal etc. such as platinum is used as the catalyst.

Apart from other problems such as improving durability and output density etc., cost reduction is the most major problem for putting the PEFC (or PEMFC) into practical use.

Since the PEFC (or PEMFC) at present employs expensive platinum as the electrode catalyst, an alternate catalyst material is strongly desired to fully promote the PEFC (or PEMFC). As more platinum is used in the air electrode than in the fuel electrode, an alternative to platinum (namely, a non-platinum catalyst) with a high level of catalytic performance for oxygen-reduction on the air electrode is particularly well under development.

A mixture of a noble metal and nitride of iron (a transition metal) described in Patent document 1 is an example of a non-platinum catalyst for the air electrode. In addition, a nitride of molybdenum (a transition metal) described in Patent document 2 is another example.

Non-patent document 1 reports that a partially-oxidized tantalum carbonitride has both excellent stability and catalytic performance.

In addition, Patent document 3 describes an MEA employing a non-platinum catalyst. A conventional method which is used for a platinum catalyst and is described, for example, in Patent document 4 and Patent document 5 etc. is employed in the Patent document 3 as a method to make the non-platinum catalyst into an electrode catalyst layer.

<Patent document 1>: JP-A-2005-44659.

<Patent document 2>: JP-A-2005-63677.

<Patent document 3>: JP-A-2008-270176.

<Patent document 4>: JP-B-H02-48632 (JP-A-H01-62489).

<Patent document 5>: JP-A-H05-36418.

<Non-patent document 1>: “Journal of The Electrochemical Society”, Vol. 155, No. 4, pp. B400-B406 (2008).

When used in an acidic electrolyte, the catalysts which are described in the Patent document 1 and the Patent document 2 mentioned above has insufficient oxygen reduction ability, and further, some of them dissolve.

The oxide type non-platinum catalyst which is described in the Non-patent document 1, while having a high level of catalytic ability for oxygen reduction, is not supported by (or loaded on) carbon particles unlike a familiar platinum catalyst. Thus, it is necessary to newly develop an appropriate manufacturing method for making such a non-platinum catalyst into an electrode catalyst layer.

Incidentally, the Patent document 4 and Patent document 5 are not suitable for a non-platinum catalyst since they are literatures related only to a platinum catalyst. Accordingly, it is not possible to make a desirable electrode catalyst layer by applying the methods in the Patent document 4 and Patent document 5 to the non-platinum catalyst in the Patent document 3.

It is an object of the present invention to provide a manufacturing method of an electrode catalyst layer for a fuel cell with a high power generation performance when a non-platinum catalyst such as of oxide type etc. is used as the catalyst, along with an MEA for such a fuel cell and such a PEFC (or PEMFC) itself.

### SUMMARY OF THE INVENTION

As a result of dedicated research, the applicants have succeeded in solving the problems mentioned above, and have accomplished the present invention.

A first aspect of the present invention is a manufacturing method of an electrode catalyst layer of a fuel cell, the electrode catalyst layer including a first polymer electrolyte, a second polymer electrolyte, a catalyst and carbon particles, the method including a process 1 of preparing a first catalyst ink in which the catalyst and the first polymer electrolyte are dispersed in a first solvent, a process 2 of drying the first catalyst ink to obtain a catalyst embedded in first polymer electrolyte, a process 3 of preparing a second catalyst ink in which the catalyst embedded in first polymer electrolyte, the second polymer electrolyte and the carbon particles are dispersed in a second solvent, and a process 4 of coating the second catalyst ink on a substrate and drying the second catalyst ink to form an electrode catalyst layer, wherein the substrate is any one selected from the group consisting of a gas diffusion layer, a transfer sheet and a polymer electrolyte membrane, and wherein a ratio of relative permittivity between the first solvent the said second solvent is in the range of 1.2:1 to 25:1 at 20° C.

It becomes possible to uniformly embed the catalyst in the first polymer electrolyte and to make it difficult for the first polymer electrolyte in which the catalyst is embedded to dissolve in the second solvent by selecting a solvent having smaller relative permittivity than the first solvent as the second solvent.

A second aspect of the present invention is a manufacturing method of an electrode catalyst layer of a fuel cell, the electrode catalyst layer including a first polymer electrolyte, a second polymer electrolyte, a catalyst and carbon particles, the method including a process 1 of preparing a first catalyst ink in which the carbon particles and the first polymer electrolyte are dispersed in a first solvent, a process 2 of drying the first catalyst ink to obtain carbon particles embedded in first polymer electrolyte, a process 3 of preparing a second catalyst ink in which the carbon particles embedded in first polymer electrolyte, the second polymer electrolyte and the catalyst are dispersed in a second solvent, and a process 4 of coating the second catalyst ink on a substrate and drying the second catalyst ink to form an electrode catalyst layer, wherein the substrate is any one selected from the group consisting of a gas diffusion layer, a transfer sheet and a polymer electrolyte membrane, and wherein a ratio of relative permittivity between the first solvent the said second solvent is in the range of 1.2:1 to 25:1 at 20° C.

It becomes possible to uniformly embed the carbon particles in the first polymer electrolyte and to make it difficult for the first polymer electrolyte in which the carbon particles are embedded to dissolve in the second solvent by selecting a solvent having smaller relative permittivity than the first solvent as the second solvent.

In addition, a third aspect of the present invention is that a ratio between the catalyst and the first polymer electrolyte in the catalyst embedded in the first polymer electrolyte in the process 2 in the first aspect of the present invention is in the range of 1:0.01 to 1:30 by weight.

In addition, a fourth aspect of the present invention is that a ratio between the carbon particles and the first polymer electrolyte in the carbon particles embedded in the first polymer electrolyte in the process 2 in the second aspect of the present invention is in the range of 1:0.1 to 1:20 by weight.

An electrode catalyst layer having a good performance can be obtained if the third aspect and fourth aspect of the present invention are satisfied.

In addition, a fifth aspect of the present invention is that the carbon particles and the catalyst embedded in first polymer electrolyte are preliminarily mixed together without adding any solvent before performing the process 3 in the third aspect of the present invention.

In addition, a sixth aspect of the present invention is that the catalyst and the carbon particles embedded in first polymer electrolyte are preliminarily mixed together without adding any solvent before performing the process 3 in the fourth aspect of the present invention.

An electrode catalyst layer having a good performance can be obtained if the fifth aspect and sixth aspect of the present invention are satisfied.

In addition, a seventh aspect of the present invention is that the catalyst is a positive electrode active material and contains at least one transition metal selected from the group consisting of Ta, Nb, Tl and Zr in the first to sixth aspects of the present invention. Then, an electrode catalyst layer having a good performance can be obtained.

In addition, an eighth aspect of the present invention is that the catalyst is a product obtained by partially-oxidizing a carbonitride of the transition metal in an atmosphere including oxygen in the seventh aspect of the present invention. Then, an electrode catalyst layer having a good performance can be obtained.

In addition, a ninth aspect of the present invention is that the transition metal is Ta in the eighth aspect of the present invention. Then, an electrode catalyst layer having a good performance can be obtained.

In addition, a tenth aspect of the present invention is an MEA having a pair of electrode catalyst layers, a proton conductive polymer electrolyte and a pair of gas diffusion layers, wherein the proton conductive polymer electrolyte is interposed between the pair of electrode catalyst layers, wherein the pair of electrode catalyst layers are interposed between the pair of gas diffusion layers, and wherein at least one of the pair of electrode catalyst layers is manufactured by the method according to any one aspect from the first aspect to ninth aspect of the present invention. A good performance is achieved in the MEA.

In addition, a eleventh aspect of the present invention is a fuel cell having a pair of separators and an MEA according to the tenth aspect of the present invention, wherein the MEA is interposed between the pair of separators. A good performance is achieved in the fuel cell.

The present invention makes it possible to increase active reaction sites in an electrode catalyst layer containing a polymer electrolyte, catalyst and carbon particles by embedding the catalyst, which has a specific surface area smaller than that of carbon particles in the present invention, in the polymer electrolyte for the purpose of improving proton conductivity on a surface of the catalyst, and consequently, an electrode catalyst layer for a fuel cell having a high level of power generation performance is provided. It is possible to evenly embed the catalyst in the polymer electrolyte by employing a first solvent for a first catalyst ink and a second solvent for a second catalyst ink which meet the condition that relative permittivity of the second solvent is smaller than that of the first solvent. On such an occasion, it is also possible to make the polymer electrolyte which embeds the catalyst hardly dissolve in the second solvent.

### BRIEF DESCRIPTION OF THE DRAWINGS

FIG. 1 is a cross sectional schematic diagram of an MEA of an embodiment of the present invention.

FIG. 2 is an exploded exemplary diagram of a PEFC (or PEMFC) of an embodiment of the present invention.

### DESCRIPTION OF SYMBOLS AND NUMERALS

1: Polymer electrolyte membrane (PEM)

2 and 3: Electrode catalyst layer

12: Membrane electrode assembly (MEA)

4 and 5: Gas diffusion layer (GDL)

6: Air electrode or Cathode

7: Fuel electrode or Anode

8: Gas flow path

9: Coolant channel (Cooling water path)

10: Separator

### EMBODIMENT OF THE INVENTION

An MEA of an embodiment of the present invention is described below. Incidentally, embodiments of the present invention are not limited to the embodiment presented below. It is possible to implement changes such as a design variation etc. in accordance with knowledge of a person having skill in the art. The embodiments of the present invention also include a derivative embodiment with such changes.

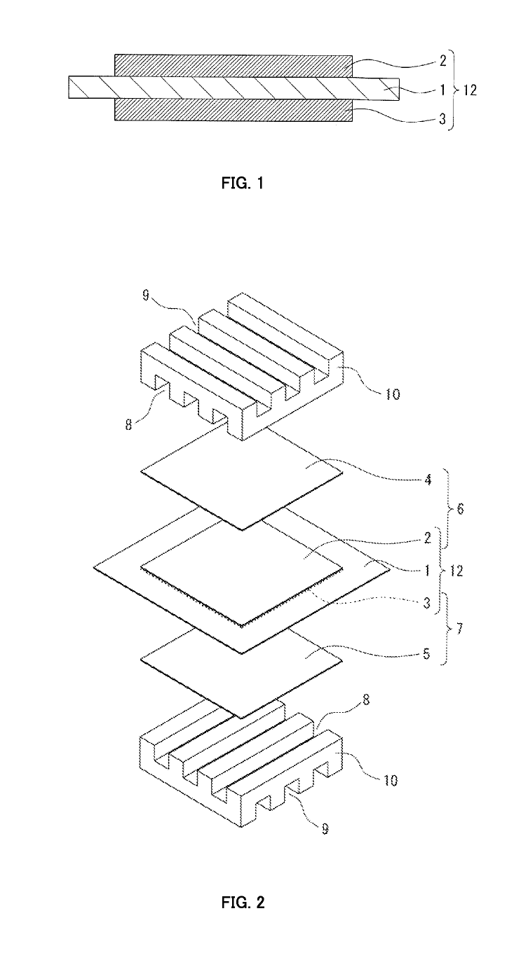

FIG. 1 is a cross sectional schematic diagram illustrating an MEA 12 of an embodiment of the present invention. It is observed in FIG. 1 that the MEA 12 has a PEM 1, an electrode catalyst layer 2 (on an air electrode side) which is arranged on a surface of the PEM 1, and an electrode catalyst layer 3 (on a fuel electrode side) which is arranged on the other surface of the PEM 1.

FIG. 2 is an exploded exemplary diagram of a PEFC (or PEMFC) of an embodiment of the present invention. It is observed in FIG. 2 that in the PEFC (or PEMFC), a gas diffusion layer (on the air electrode side) 4 and a gas diffusion layer (on the fuel electrode side) 5, respectively, are arranged facing the electrode catalyst layer 2 and electrode catalyst layer 3 in the MEA 12. These are structures of an air electrode (a cathode) 6 and a fuel electrode (an anode) 7. Moreover, a pair of separators 10 is arranged in the fuel cell, wherein each separator 10 is made of a conductive and impermeable material and has a gas flow path 8 for transporting a gas on one surface and a cooling water path 9 for transporting cooling water on the opposite surface. A fuel gas such as hydrogen gas for example, is supplied through the gas flow path 8 on the separator 10 of the fuel electrode 7 whereas an oxidant gas such as a gas containing oxygen for example, is supplied through the gas flow path 8 on the separator 10 of the air electrode 6. Then, an electromotive force is generated between the fuel electrode and the air electrode by an electrode reaction between hydrogen as the fuel gas and the oxygen gas under the presence of the catalyst.

The fuel cell illustrated in FIG. 2 is one of a so-called “unit cell” structured fuel cell, in which the polymer electrolyte membrane (PEM) 1, the electrode catalyst layers 2 and 3, and the gas diffusion layers 4 and 5 are interposed between the pair of separators 10, while the present invention also includes a fuel cell in which a plurality of unit cells are stacked via the separator 10.

In a manufacturing method of the electrode catalyst layer of the embodiment, it is possible to increase active reaction sites by preliminarily embedding a catalyst which has a smaller specific surface area than carbon particles in a polymer electrolyte so as to improve proton conductivity on a surface of the catalyst. In conventional methods, which include no process of preliminarily embedding the catalyst in a polymer electrolyte, it is difficult to increase active reaction sites because the carbon particles which have a larger specific surface area are embedded in the polymer electrolyte more dominantly or preferentially than the catalyst, thereby the catalyst have low proton conductivity on the surface when the electrode catalyst layer is fabricated. Incidentally, it is possible even in conventional methods to improve proton conductivity on the surface of the catalyst by employing a high concentration of polymer electrolyte. Such a process, however, ends in an excessive addition of the polymer electrolyte with respect to the amount of the carbon particles, which hardly brings about an improvement of output performance.

In the case where a catalyst is preliminarily embedded in a polymer electrolyte as is in the above case, it is possible during preparation of a first catalyst ink, in which the catalyst and the first polymer electrolyte is dispersed in a solvent, to control a weight ratio of the catalyst to the polymer electrolyte in a resultant catalytic product in a dry state by adjusting a composition of the first catalyst ink. It is preferable that the weight ratio of the catalyst to the polymer electrolyte is in the range of 1:0.01 to 1:30. In the case where a weight ratio of the polymer electrolyte to the catalyst is lower than 0.01, output performance may not be improved since proton conductivity on a surface of the catalyst is hardly improved and thus it is difficult to increase active reaction sites. On the other hand, in the case where the weight ratio of the polymer electrolyte to the catalyst is higher than 30, output performance may not be improved since gas diffusion to the active reaction sites is inhibited.

In addition, in the case where the catalyst which has a smaller specific surface area than the carbon particles is preliminarily embedded in the first polymer electrolyte, it is preferable that a process of mixing the catalyst which has been embedded in the first polymer electrolyte (hereinafter also referred to as “the catalyst embedded in the first polymer electrolyte”) together with the carbon particles without using a solvent is implemented before a process of dispersion into a second solvent in a process of preparing a second catalyst ink, in which a second polymer electrolyte, the carbon particles and the catalyst embedded in the first polymer electrolyte are dispersed in the second solvent. Unless the process of mixing without a solvent is performed, the output performance may not be improved due to poor contacts between the catalyst and the carbon particles, which makes it difficult to increase active reaction sites.

In addition, in another manufacturing method of an electrode catalyst layer of the embodiment, it is possible to reduce a specific surface area of carbon particles which have a larger specific surface area than a catalyst by preliminarily embedding the carbon particles in a polymer electrolyte. In conventional methods, which include no process of preliminarily embedding the carbon particles in the polymer electrolyte, it is difficult to increase active reaction sites because the carbon particles which have a larger specific surface area are embedded in the polymer electrolyte more dominantly or preferentially than the catalyst, thereby keeping the catalyst to have low proton conductivity on the surface when the electrode catalyst layer is fabricated.

In the case where carbon particles are preliminarily embedded in a polymer electrolyte as are in the above case, it is possible during a preparation of a first catalyst ink, in which the carbon particles and the first polymer electrolyte is dispersed in a first solvent, to control a weight ratio of the carbon particles to the polymer electrolyte in a resultant product in a dry state by adjusting a composition of the first catalyst ink. It is preferable that the weight ratio of the carbon particles to the polymer electrolyte is in the range of 1:0.1 to 1:20. In the case where a weight ratio of the polymer electrolyte to the carbon particles is lower than 0.1, output performance may not be improved since the specific surface area of the carbon particles is hardly reduced. On the other hand, in the case where the weight ratio of the polymer electrolyte to the carbon particles is higher than 20, output performance may not be improved since gas diffusion to the active reaction sites is inhibited due to an excessive amount of the polymer electrolyte.

In addition, in the case where the carbon particles which have a larger specific surface area than the catalyst is preliminarily embedded in the first polymer electrolyte, it is preferable that a process of mixing the carbon particles which have been embedded in the first polymer electrolyte (hereinafter also referred to as “the carbon particles embedded in the first polymer electrolyte”) together with the catalyst without using a solvent is implemented before a process of dispersion into a second solvent in a process of preparing a second catalyst ink, in which a second polymer electrolyte, the catalyst and the carbon particles embedded in the first polymer electrolyte are dispersed in the second solvent. Unless the process of mixing without a solvent is performed, the output performance may not be improved due to poor contacts between the carbon particles and the catalyst, which makes it difficult to increase active reaction sites.

In addition, in the manufacturing methods of an electrode catalyst layer of the embodiment, it is preferable that a relative permittivity ratio between the first solvent used in the first catalyst ink and the second solvent used in the second catalyst ink is in the range of 1.2:1 to 25:1 at a temperature of 20° C. It is more preferable if the ratio is the range of 3:1 to 15:1. In the case where relative permittivity of the first solvent is not 1.2 or more times as high as that of the second solvent, the first polymer electrolyte, in which the catalyst or the carbon particles are embedded, may dissolve in the second solvent resulting in a failure to improve the output performance. On the other hand, in the case where relative permittivity of the first solvent is more than 25 times higher than that of the second solvent, appropriate formation of the electrode catalyst layer may be inhibited resulting in a failure to improve the output performance.

It is possible to use a generally-used catalyst material as the catalyst of the embodiment of the present invention. It is preferably possible in the present invention to use a positive electrode active material of PEMFC which contains at least one transition metal selected from the group consisting of Ta, Nb, Tl and Zr, as an alternative to platinum in the air electrode.

In addition, it is preferably possible to use a carbonitride of these transition metals which is partially oxidized in an atmosphere including oxygen as the catalyst. Specifically, a material obtained by partial oxidation of tantalum carbonitride (TaCN), that is TaCNO, which has a specific surface area in the range of about 1-20 m²/g is included in such carbonitrides.

Any carbons which are in the shape of particles, electrically conductive and unreactive with the catalyst can be used as the carbon particles related to the embodiment of the present invention. For example, carbon blacks, graphites, black leads, active carbons, carbon fibers, carbon nano-tubes and fullerenes can be used. It is preferable that the carbon particles have a particle diameter in the range of 10-1000 nm since it becomes difficult to form electron conduction paths if the carbon particles are excessively small while gas diffusibility in the electrode catalyst layer and/or catalyst use efficiency decline(s) if the carbon particles are excessively large. It is more preferable that the carbon particles have a particle diameter in the range of 10-100 nm. The carbon particles have a specific surface area in the range of about 10-1600 m²/g.

The MEA and the fuel cell of the present invention are described in detail below. Any material having proton conductivity can be used as the PEM 1 in the membrane electrode assembly 12 of the embodiment of the present invention. For example, a fluorine-based polymer electrolyte and a hydrocarbon-based polymer electrolyte can be used. Examples of the fluorine-based polymer electrolyte are Nafion® (made by Du Pont), Flemion® (made by ASAHI GLASS CO., LTD.), Aciplex® (made by Asahi KASEI Cooperation), and Gore Select® (by Japan Gore-Tex Inc.) etc. Examples of the hydrocarbon-based polymer electrolyte are an electrolyte of sulfonated polyether ketone, sulfonated polyether sulfone, sulfonated polyether ether sulfone, sulfonated polysulfide, and sulfonated polyphenylene etc. Among others, materials of Nafion® series made by Du Pont can preferably be used as the PEM 1. Examples of the hydrocarbon-based polymer electrolyte are electrolytes of sulfonated polyether ketone, sulfonated polyether sulfone, sulfonated polyether ether sulfone, sulfonated polysulfide, and sulfonated polyphenylene etc.

Any material having proton conductivity can be used as the polymer electrolyte contained in a catalyst ink related to the embodiment of the present invention, and fluorine-based polymer electrolytes and hydrocarbon-based polymer electrolytes similar to those of the PEM 1 can be used. For example, materials of Nafion® series made by Du Pont etc. can be used as the fluorine-based polymer electrolyte. Electrolytes of sulfonated polyether ketone, sulfonated polyether sulfone, sulfonated polyether ether sulfone, sulfonated polysulfide, and sulfonated polyphenylene etc. can be used as the hydrocarbon-based polymer electrolyte. Among others, materials of Nafion® series made by Du Pont can preferably be used as the polymer electrolyte. It is preferable that the same material used as the PEM 1 is employed in consideration of adhesion between the electrode catalyst layer 2 or 3 and the PEM 1.

In this embodiment, two polymer electrolytes, namely, the first polymer electrolyte, in which either the catalyst or the carbon particles are embedded, and the second polymer electrolyte, which is mixed together with either the catalyst which has been embedded in the first polymer electrolyte or the carbon particles which have been embedded in the first polymer electrolyte, are used. It is possible to use materially the same polymer electrolytes both as the first polymer electrolyte and as the second polymer electrolyte. On the other hand, it is also possible to use a different material as the second polymer electrolyte from a material used as the first polymer electrolyte.

A solvent in which the polymer electrolyte is dissolved with high fluidity or dispersed as a fine gel and yet in which the catalyst and the polymer electrolyte do not corrade can be used as a solvent of the catalyst ink.

It is preferable that the solvent contains at least one volatile organic solvent. Alcohol solvents such as methanol, ethanol, 1-propanol, 2-propanol, 1-butanol, 2-butanol, isobutyl alcohol, tert-butyl alcohol and pentanol etc., ketone solvents such as acetone, methyl ethyl ketone, pentanone, methyl isobutyl ketone, heptanone, cyclohexanone, methyl cyclohexanone, acetonyl acetone and diisobutyl ketone etc., ether solvents such as tetrahydrofuran, dioxane, diethylene glycol dimethyl ether, anisole, methoxytoluene and dibutyl ether etc., and other polar solvents such as dimethylformamide, dimethylacetamide, N-methylpyrrolidone, ethylene glycol, diethylene glycol, diacetone alcohol and 1-methoxy-2-propanol etc. are often used although the solvent is not limited to these. In addition, any solvent mixture of a combination of a plurality of these solvents may also be used as the solvent.

In addition, solvents of a lower alcohol have a high risk of igniting. When using one of such solvents, a mixture with water is preferably used as the solvent since water which is highly soluble in the polymer electrolyte can be contained without serious problems. There is no particular limitation to a water additive amount unless the polymer electrolyte is separated from the solvent to generate white turbidity or turn into a gel.

In addition, it is preferable that a relative permittivity ratio between the first solvent used in the first catalyst ink and the second solvent used in the second catalyst ink is in the range of 1.2:1 to 25:1 at a temperature of 20° C. Moreover, it is preferable that the relative permittivity of the first solvent at 20° C. (ε₁) meets the condition of ε₁≧10 and the relative permittivity of the second solvent at 20° C. (ε₂) meets the condition of 3≦ε₂≦10.

Solvents such as isobutyl alcohol, acetone, ethanol and water etc., for example, satisfy the condition of relative permittivity ε₁≧10. In addition, solvents such as ethyl ether and butyl acetate etc., for example, satisfy the condition of relative permittivity 3≦≦ε₂≦10.

It is possible to make the relative permittivity ratio between the first solvent and the second solvent in the range of 1.2:1 to 25:1 at 20° C. if the first solvents and the second solvents are appropriately selected from the above recited solvents in terms of a relative permittivity relationship. It is also useful to blend a plurality of solvents having different relative permittivity in order to adjust the relative permittivity ratio.

Incidentally, relative permittivity of a solvent can be measured, for example, by a permittivity meter.

A dispersant may be contained in the catalyst ink in order to disperse the catalyst and/or the carbon particles. An anion surfactant, a cation surfactant, an amphoteric (or ampholytic) surfactant and a non-ionic surfactant etc. can be used as the dispersant.

Specifically, for example, carboxylate type surfactants such as alkyl ether carbonates, ether carbonates, alkanoyl sarcosines, alkanoyl glutaninates, acyl glutaninates, oleic acid N-methyltaurine, potassium oleate diethanolamine salts, alkyl ether sulfate triethanolamine salts, polyoxyethylene alkyl ether sulfate triethanolamine salts, amine salts of specialty modified polyether ester acids, amine salts of higher fatty acid derivatives, amine salts of specialty modified polyester acids, amine salts of large molecular weight polyether ester acids, amine salts of specialty modified phosphate esters, amideamine salts of large molecular weight polyether ester acids, amide-amine salts of specialty aliphatic acid derivatives, alkylamine salts of higher fatty acids, amide-amine salts of large molecular weight polycarboxylic acids, sodium laurate, and sodium stearate, sodium oleate etc., sulfonate type surfactants such as dialkylsulfosuccinates, salts of 1,2-bis(alkoxycarbonyl)-1-ethanesulfonic acid, alkylsulfonates, paraffin sulfonates, alpha-olefin sulfonates, linear alkylbenzene sulfonates, alkylbenzene sulfonates, polynaphthylmethane sulfonates, naphthalenesulfonate-formaline condensates, alkylnaphthalene sulfonates, alkanoylmethyl taurides, sodium salt of lauryl sulfate ester, sodium salt of cetyl sulfate ester, sodium salt of stearyl sulfate ester, sodium salt of oleyl sulfate ester, lauryl ether sulfate ester salt, sodium alkylbenzene sulfonates, and oil-soluble alkylbenzene sulfonates etc., sulfate ester type surfactants such as alkylsulfate ester salts, alkyl sulphates, alkyl ether sulphates, polyoxyethylene alkyl ether sulfates, alkyl polyethoxy sulfates, polyglycol ether sulfates, alkyl polyoxyethylene sulfates, sulfonate oil, and highly sulfonated oil etc., phosphate ester type surfactants such as monoalkyl phosphates, dialkyl phosphates, monoalkyl phosphate esters, dialkyl phosphate esters, alkyl polyoxyethylene phosphates, alkyl ether phosphates, alkyl polyethoxy phosphates, polyoxyethylene alkyl ethers, alkylphenyl polyoxyethylene phosphate, alkylphenyl ether phosphates, alkylphenyl polyethoxy phosphates, polyoxyethylene alkylphenylether phosphates, disodium salts of higher alcohol phosphate monoester, disodium salts of higher alcohol phosphate diester, and zinc dialkyl dithiophosphate etc. can be used as the anion surfactant mentioned above.

For example, benzyldimethyl [2-{2-(p-1,1,3,3-tetramethylbutylphenoxy) ethoxy} ethyl] ammonium chloride, octadecylamine acetate, tetradecylamine acetate, octadecyltrimethylammonium chloride, beef tallow trimethylammonium chloride, dodecyltrimethylammonium chloride, palm trimethylammonium chloride, hexadecyltrimethylammonium chloride, behenyltrimethylammonium chloride, palm dimethylbenzylammonium chloride, tetradecyldimethylbenzylammonium chloride, octadecyldimethylbenzylammonium chloride, dioleyldimethylammonium chloride, 1-hydroxyethyl-2-beef tallow imidazoline quaternary salt, 2-heptadecenyl-hydroxyethyl imidazoline, stearamideethyldiethylamine acetate, stearamideethyldiethylamine hydrochloride, triethanolamine monostearate formate, alkylpyridium salts, higher alkylamine-ethylene oxide adducts, polyacrylamide amine salts, modified polyacrylamide amine salts, and perfluoroalkyl quaternary ammonium iodide etc. can be used as the cation surfactant stated above.

For example, dimethyl cocobetaine, dimethyl lauryl betaine, sodium laurylaminoethyl glycine, sodium laurylaminopropionate, stearyl dimethyl betaine, lauryl dihydroxyethyl betaine, amide betaine, imidazolinium betaine, lecithin, sodium 3-(ω)-fluoroalkanoyl-N-ethylamino)-1-propane sulfonate, and N-{3-(perfluorooctanesulfoneamide) propyl}-N,N-dimethyl-N-carboxymethylene ammonium betaine etc. can be used as the zwitterionic surfactant mentioned above.

For example, coconut fatty acid diethanolamide (1:2 type), coconut fatty acid diethanolamide (1:1 type), beef tallowate diethanolamide (1:2 type), beef tallowate diethanolamide (1:1 type), oleic acid diethanolamide (1:1 type), hydroxyethyl laurylamine, polyethylene glycol laurylamine, polyethylene glycol cocoamine, polyethylene glycol stearylamine, polyethylene glycol beef tallow amine, polyethylene glycol beef tallow propylenediamine, polyethylene glycol dioleylamine, dimethyllaurylamine oxide, dimethylstearylamine oxide, dihydroxyethyllaurylamine oxide, perfluoroalkylamine oxides, polyvinylpyrrolidone, higher alcohol-ethylene oxide adducts, alkyl phenol-ethylene oxide adducts, fatty acid-ethylene oxide adducts, propylene glycol-ethylene oxide adduct, fatty acid esters of glycerin, fatty acid esters of pentaerithritol, fatty acid esters of sorbitol, fatty acid esters of sorbitan, and fatty acid esters of sugar etc. can be used as the nonionic surfactant mentioned above.

Among these, sulfonate type of anion surfactants such as alkylbenzene sulfonic acids, oil soluble alkylbenzene sulfonic acids, α-olefin sulfonic acids, sodium alkylbenzene sulfonates, oil soluble alkylbenzene sulfonates, and α-olefin sulfonates are preferable considering aspects such as a dispersing effect for carbons and an influence of the residual dispersant on catalyst performance.

The catalyst ink receives a dispersion treatment if necessary. Particle-size and viscosity of the catalyst ink can be controlled by a condition of the dispersion treatment. It is possible to perform the dispersion treatment by various types of equipment. Treatments by a ball mill, a roll mill, a shear mill and a wet type mill, and an ultrasonic dispersion treatment etc. are examples. Alternatively, a homogenizer that performs agitation by a centrifugal force may be used in the dispersion treatment.

It is preferable that the amount of solid content in the catalyst ink is in the range of 1-50% by weight. In the case where the amount of solid content is excessively large, cracks tend to be easily created on a surface of the electrode catalyst layer since the viscosity of the catalyst ink is too high. On the other hand, in the case where the amount of solid content is too small, a forming rate of the catalyst layer becomes too low to ensure reasonable productivity. The catalyst, the carbon particles and the polymer electrolyte are included in the solid content. The one containing a higher amount of the carbon particles has higher viscosity, and vice versa when comparing the catalyst inks containing the same amounts of the solid content. Hence, it is preferable that a ratio of the carbon particles with respect to a total solid content is appropriately adjusted within the range of 10-80% by weight. At this time, it is preferable that the viscosity of the catalyst ink is in the range of 0.1-500 cP, and more preferable in the range of 5-100 cP. In addition, a dispersant may be added to the catalyst ink in order to control the viscosity when dispersing the solid content therein.

In addition, the catalyst ink may include a pore forming agent. Fine pores are created by removing the pore forming agent after the electrode catalyst is formed. Examples of the pore forming agent are materials soluble in acid, alkali or water, sublimation materials such as camphor, and materials which decompose by heat. If the pore former is soluble in warm water, it can be removed by water produced during the power generation.

Inorganic salts (soluble to acid) such as calcium carbonate, barium carbonate, magnesium carbonate, magnesium sulfate, and magnesium oxide etc., inorganic salts (soluble to alkali aqueous solution) such as alumina, silica gel, and silica sol etc., metals (soluble to acid and/or alkali) such as aluminum, zinc, tin, nickel, and iron etc., inorganic salts (soluble to water) aqueous solutions of sodium chloride, potassium chloride, ammonium chloride, sodium carbonate, sodium sulfate, and monobasic sodium phosphate etc., and water soluble organic compounds such as polyvinyl alcohol, and polyethylene glycol etc. are available as the pore forming agent soluble in acid, alkali or water. Not only a single material but a plurality of these together can be effectively used.

In the manufacturing method of an electrode catalyst layer of the embodiment, the catalyst embedded in the first polymer electrolyte (or the carbon particles embedded in the first polymer electrolyte) can be obtained by coating the first catalyst ink, in which the catalyst (or the carbon particles) and the first polymer electrolyte are dispersed in the first solvent, onto a transfer sheet followed by drying the coated first catalyst ink. Alternatively, the catalyst embedded in the first polymer electrolyte (or the carbon particles embedded in the first polymer electrolyte) can be directly obtained by spraying into a dry atmosphere.

In fabricating the electrode catalyst layer from the second catalyst ink, in which the catalyst embedded in the first polymer electrolyte, the carbon particles and the second polymer electrolyte are dispersed in the second solvent (or in which the carbon particles embedded in the first polymer electrolyte, the catalyst and the second polymer electrolyte are dispersed in the second solvent), in the manufacturing method of an electrode catalyst layer of the embodiment, the electrode catalyst layer is fabricated by a process of coating the second catalyst ink on a substrate and drying the coated second catalyst ink. In the case where a gas diffusion layer or a transfer sheet is used as the substrate, the resultant electrode catalyst layer is stuck to both surfaces of the PEM by an additional paste process. In another case of the embodiment, the PEM is used as the substrate so that it is possible to directly form the electrode catalyst layer on both surfaces of the PEM by coating the second catalyst ink on the both surfaces of the PEM.

At this time, a doctor blade method, a dipping method, a screen printing method, a roll coating method and a spray method etc. can be used as the coating method. Among these, the spray method such as, for example, a pressure spray method, an ultrasonic spray method, and an electrostatic spray method etc. has an advantage that agglutination hardly occurs when drying the coated catalyst ink so that a homogenized and highly porous electrode catalyst layer is obtained.

A gas diffusion layer, a transfer sheet or a PEM can be used as the substrate in the manufacturing method of the electrode catalyst layer related to the present invention.

The transfer sheet which is used as the substrate is principally made of a material having good transfer properties. For example, fluororesins such as ethylene tetrafluoroethylene copolymer (ETFE), tetrafluoroethylene hexafluoroethylene copolymer (FEP), tetrafluoroethylene perfluoroalkyl vinyl ether copolymer (PFA), and polytetrafluoroethylene (PTFE) etc. can be used. In addition, polymer sheets or polymer films such as polyimide, polyethylene terephthalate (PET), polyamide (nylon), polysulfone (PSF), polyethersulfone (PES), polyphenylene sulfide (PPS), polyether ether ketone (PEEK), polyetherimide (PEI), polyarylate (PAR), and polyethylene naphthalate (PEN) etc. can be used as the transfer sheet.

In the case where such a transfer sheet is used as the substrate, it is possible to peel off and remove the transfer sheet after an electrode catalyst layer is stuck to the PEM so as to make an MEA in which electrode catalyst layers are arranged on both sides of the PEM. A material having gas diffusion properties and electric conductivity can be used as a gas diffusion layer. Specifically, a carbon cloth, a carbon paper and a porous carbon such as unwoven carbon fabric can be used as the gas diffusion layer. Such a gas diffusion layer can also be used as the substrate. In the case where a gas diffusion layer is used as the substrate, it is unnecessary to peel off the substrate which acts as the gas diffusion layer after the electrode catalyst layer is stuck to the PEM.

In the case where the gas diffusion layer is used as the substrate, a filling (or sealing) layer may preliminarily be formed on the gas diffusion layer before the catalyst ink is coated. The filling (or sealing) layer is formed to prevent the catalyst ink from seeping into the gas diffusion layer. If the filling layer is preliminarily formed, the catalyst ink is accumulated on the filling layer and a three-phase boundary is formed even when a small amount of the catalyst ink is coated. Such a filling layer can be formed, for example, by dispersing carbon particles in a fluororesin solution and sintering the solution at a temperature higher than the melting point of the fluororesin. Polytetrafluoroethylene (PTFE) etc. can be used as the fluororesin.

A carbon separator and a metal separator etc. can be used as the separator in the present invention. The separator may incorporate the gas diffusion layer. In the case where the separator or the electrode catalyst layer also acts as the gas diffusion layer, it is unnecessary to arrange any separate gas diffusion layers. A fuel cell can be fabricated by joining additional equipment such as gas supply equipment and cooling equipment etc. to the MEA having the components described above.

### EXAMPLES

Specific examples and comparative examples of a manufacturing method of an MEA of the present invention will be described below. The present invention, however, is not limited by the examples below.

Examples 1 to 4 and comparative examples 1 and 2 are described.

### Example 1

### <Preparing a First Catalyst Ink>

A catalyst (TaCNO, specific surface area: 9 m²/g) and a 20% by weight solution (solvent: IPA, ethanol and water) of a polymer electrolyte (Nafion®, made by DuPont) were mixed together in a first solvent followed by performing a dispersion treatment using a planetary ball mill (product code: P-7, by Fritsch Japan Co., Ltd). A zirconia pot and zirconia balls were used for the ball mill. The resultant first catalyst ink had a 1:0.25 by weight composition ratio between the catalyst and the polymer electrolyte. A solvent blend of ultrapure water and 1-propanol was used as the first solvent and their blend ratio was adjusted so as to have relative permittivity of about 55 at 20° C. In addition, the first catalyst ink had a solid content of 14% by weight.

### <Forming a “Catalyst Embedded in a Polymer Electrolyte”>

A sheet of PTFE was used as a substrate for drying the first catalyst ink. The first catalyst ink was coated on the substrate by a doctor blade and dried under atmosphere at 80° C. for five minutes. Then, the resultant “catalyst embedded in the polymer electrolyte” was collected from the substrate.

<Mixing the “Catalyst Embedded in a Polymer Electrolyte” with Carbon Particles and Heating>

The “catalyst embedded in the polymer electrolyte” and carbon particles (Ketjen Black, product code: EC-300J, made by Lion Corporation, specific surface area: 800 m²/g) were mixed together using a planetary ball mill without adding a solvent. A zirconia pot and zirconia balls were used for the ball mill. The composition ratio between the “catalyst embedded in the polymer electrolyte” and carbon particles was 1:1 by weight.

### <Preparing a Second Catalyst Ink>

The resultant mixture of the “catalyst embedded in the polymer electrolyte” and the carbon particles after the heating was mixed with the 20% by weight solution of the polymer electrolyte in a second solvent followed by performing a dispersion treatment using a planetary ball mill. A zirconia pot and zirconia balls were used for the ball mill. The resultant second catalyst ink had a composition ratio of 1:1:0.8 among the catalyst, carbon particles and the polymer electrolyte. Butyl acetate was used as the second solvent, and had relative permittivity of about 5 at 20° C. In addition, the second catalyst ink had a solid content of 14% by weight.

### <Forming an Electrode Catalyst Layer>

A sheet of PTFE was used as a transfer sheet. The second catalyst ink was coated on the transfer sheet by a doctor blade and dried under atmosphere at 80° C. for five minutes. An electrode catalyst layer 2 for an air electrode was formed by adjusting the thickness in such a way that an amount of the catalyst which was loaded on the electrode catalyst layer in all was 0.4 mg/cm².

### Example 2

### <Preparing a First Catalyst Ink>

Carbon particles (Ketjen Black, product code: EC-300J, made by Lion Corporation, specific surface area: 800 m²/g) and a 20% by weight solution (solvent: IPA, ethanol and water) of a polymer electrolyte (Nafion®, made by DuPont) were mixed together in a first solvent followed by performing a dispersion treatment using a planetary ball mill (product code: P-7, by Fritsch Japan Co., Ltd). A zirconia pot and zirconia balls were used for the ball mill. The resultant first catalyst ink had a 1:0.5 by weight composition ratio between the carbon particles and the polymer electrolyte. A solvent blend of ultrapure water and 1-propanol was used as the first solvent and their blend ratio was adjusted so as to have relative permittivity of about 55 at 20° C. In addition, the first catalyst ink had a solid content of 14% by weight.

### <Forming “Carbon Particles Embedded in a Polymer Electrolyte”>

A sheet of PTFE was used as a substrate for drying the first catalyst ink. The first catalyst ink was coated on the substrate by a doctor blade and dried under atmosphere at 80° C. for five minutes. Then, the resultant “carbon particles embedded in the polymer electrolyte” was collected from the substrate.

<Mixing the “Carbon Particles Embedded in a Polymer Electrolyte” with a Catalyst and Heating>

The “carbon particles embedded in the polymer electrolyte” and a catalyst (TaCNO, specific surface area: 9 m²/g) were mixed together using a planetary ball mill without adding a solvent. A zirconia pot and zirconia balls were used for the ball mill. The composition ratio between the carbon particles and the catalyst was 1:1 by weight.

### <Preparing a Second Catalyst Ink>

The resultant mixture of the “carbon particles embedded in the polymer electrolyte” and the catalyst after the heating was mixed with the 20% by weight solution of the polymer electrolyte in a second solvent followed by performing a dispersion treatment using a planetary ball mill. A zirconia pot and zirconia balls were used for the ball mill. The resultant second catalyst ink had a composition ratio of 1:1:0.8 among the catalyst, carbon particles and the polymer electrolyte. Butyl acetate was used as the second solvent, and had relative permittivity of about 5 at 20° C. In addition, the second catalyst ink had a solid content of 14% by weight.

### <Forming an Electrode Catalyst Layer>

A sheet of PTFE was used as a transfer sheet. The second catalyst ink was coated on the transfer sheet by a doctor blade and dried under atmosphere at 80° C. for five minutes. An electrode catalyst layer 2 for an air electrode was formed by adjusting the thickness in such a way that an amount of the catalyst which was loaded on the electrode catalyst layer in all was 0.4 mg/cm².

### Example 3

### <Preparing a First Catalyst Ink>

A catalyst (TaCNO, specific surface area: 9 m²/g) and a 20% by weight solution (solvent: IPA, ethanol and water) of a polymer electrolyte (Nafion®, made by DuPont) were mixed together in a first solvent followed by performing a dispersion treatment using a planetary ball mill (product code: P-7, by Fritsch Japan Co., Ltd). A zirconia pot and zirconia balls were used for the ball mill. The resultant first catalyst ink had 1:0.25 by weight composition ratio between the catalyst and the polymer electrolyte. A solvent blend of ultrapure water and 1-propanol was used as the first solvent and their blend ratio was adjusted so as to have relative permittivity of about 55 at 20° C. In addition, the first catalyst ink had a solid content of 14% by weight.

### <Forming a “Catalyst Embedded in a Polymer Electrolyte”>

A sheet of PTFE was used as a substrate for drying the first catalyst ink. The first catalyst ink was coated on the substrate by a doctor blade and dried under atmosphere at 80° C. for five minutes. Then, the resultant “catalyst embedded in the polymer electrolyte” was collected from the substrate.

<Mixing the “Catalyst Embedded in a Polymer Electrolyte” with Carbon Particles and Heating>

The “catalyst embedded in the polymer electrolyte” and carbon particles (Ketjen Black, product code: EC-300J, made by Lion Corporation, specific surface area: 800 m²/g) were mixed together using a planetary ball mill without adding a solvent. A zirconia pot and zirconia balls were used for the ball mill. The composition ratio between the “catalyst embedded in the polymer electrolyte” and carbon particles was 1:1 by weight.

### <Preparing a Second Catalyst Ink>

The resultant mixture of the “catalyst embedded in the polymer electrolyte” and the carbon particles after heating was mixed with the 20% by weight solution of the polymer electrolyte in a second solvent followed by performing a dispersion treatment using a planetary ball mill. A zirconia pot and zirconia balls were used for the ball mill. The resultant second catalyst ink had a composition ratio of 1:1:0.8 among the catalyst, carbon particles and the polymer electrolyte. A solvent blend of ultrapure water and 1-propanol was used as the second solvent and their blend ratio was adjusted so as to have relative permittivity of about 35 at 20° C. In addition, the second catalyst ink had a solid content of 14% by weight.

### <Forming an Electrode Catalyst Layer>

A sheet of PTFE was used as a transfer sheet. The second catalyst ink was coated on the transfer sheet by a doctor blade and dried under atmosphere at 80° C. for five minutes. An electrode catalyst layer 2 for an air electrode was formed by adjusting the thickness in such a way that an amount of the catalyst which was loaded on the electrode catalyst layer in all was 0.4 mg/cm².

### Example 4

### <Preparing a First Catalyst Ink>

Carbon particles (Ketjen Black, product code: EC-300J, made by Lion Corporation, specific surface area: 800 m²/g) and a 20% by weight solution (solvent: IPA, ethanol and water) of a polymer electrolyte (Nafion®, made by DuPont) were mixed together in a first solvent followed by performing a dispersion treatment using a planetary ball mill (product code: P-7, by Fritsch Japan Co., Ltd). A zirconia pot and zirconia balls were used for the ball mill. The resultant first catalyst ink had a 1:0.5 by weight composition ratio between the carbon particles and the polymer electrolyte. Water was used as the first solvent, and had relative permittivity of about 80 at 20° C. In addition, the first catalyst ink had a solid content of 14% by weight.

### <Forming “Carbon Particles Embedded in a Polymer Electrolyte”>

A sheet of PTFE was used as a substrate for drying the first catalyst ink. The first catalyst ink was coated on the substrate by a doctor blade and dried under atmosphere at 80° C. for five minutes. Then, the resultant “carbon particles embedded in the polymer electrolyte” were collected from the substrate.

<Mixing the “Carbon Particles Embedded in a Polymer Electrolyte” with a Catalyst and Heating>

The “carbon particles embedded in the polymer electrolyte” and a catalyst (TaCNO, specific surface area: 9 m²/g) were mixed together using a planetary ball mill without adding a solvent. A zirconia pot and zirconia balls were used for the ball mill. The composition ratio between the carbon particles and the catalyst was 1:1 by weight.

### <Preparing a Second Catalyst Ink>

The resultant mixture of the “carbon particles embedded in the polymer electrolyte” and the catalyst after the heating was mixed with the 20% by weight solution of the polymer electrolyte in a second solvent followed by performing a dispersion treatment using a planetary ball mill. A zirconia pot and zirconia balls were used for the ball mill. The resultant second catalyst ink had a composition ratio of 1:1:0.8 among the catalyst, carbon particles and the polymer electrolyte. A solvent blend of ultrapure toluene and 1-propanol was used as the second solvent and their blend ratio was adjusted so as to have relative permittivity of about 3.4 at 20° C. In addition, the second catalyst ink had a solid content of 14% by weight.

### <Forming an Electrode Catalyst Layer>

A sheet of PTFE was used as a transfer sheet. The second catalyst ink was coated on the transfer sheet by a doctor blade and dried under atmosphere at 80° C. for five minutes. An electrode catalyst layer 2 for an air electrode was formed by adjusting the thickness in such a way that an amount of the catalyst which was loaded on the electrode catalyst layer in all was 0.4 mg/cm².

### Comparative Example 1

### <Preparing a Catalyst Ink>

A catalyst (TaCNO, specific surface area: 9 m²/g), carbon particles (Ketjen Black, product code: EC-300J, made by Lion Corporation, specific surface area: 800 m²/g) and a 20% by weight solution (solvent: IPA, ethanol and water) of a polymer electrolyte (Nafion®, made by DuPont) were mixed together in a solvent followed by performing a dispersion treatment using a planetary ball mill (product code: P-7, by Fritsch Japan Co., Ltd). A zirconia pot and zirconia balls were used for the ball mill. The resultant catalyst ink had a composition ratio of 1:1:0.8 by weight among the catalyst, the carbon particles and the polymer electrolyte. A solvent blend of 1:1 by volume of ultrapure water and 1-propanol was used as the solvent. In addition, the first catalyst ink had a solid content of 14% by weight.

### <Forming an Electrode Catalyst Layer>

The same transfer sheet (PTFE) as is used in the Examples was used as a substrate. The catalyst ink was coated on the transfer sheet and was dried in a way similar to that of the Examples. An electrode catalyst layer 2 for an air electrode was formed by adjusting the thickness in such a way that an amount of the catalyst which was loaded on the electrode catalyst layer in all was 0.4 mg/cm².

### Comparative Example 2

### <Preparing a First Catalyst Ink>

A catalyst (TaCNO, specific surface area: 9 m²/g) and a 20% by weight solution (solvent: IPA, ethanol and water) of a polymer electrolyte (Nafion®, made by DuPont) were mixed together in a first solvent followed by performing a dispersion treatment using a planetary ball mill (product code: P-7, by Fritsch Japan Co., Ltd). A zirconia pot and zirconia balls were used for the ball mill. The resultant first catalyst ink had a 1:0.25 by weight composition ratio between the catalyst and the polymer electrolyte. A solvent blend of ultrapure water and 1-propanol was used as the first solvent and their blend ratio was adjusted so as to have relative permittivity of about 55 at 20° C. In addition, the first catalyst ink had a solid content of 14% by weight.

### <Forming a “Catalyst Embedded in a Polymer Electrolyte”>

The same substrate (PTFE) as is used in the Examples was used as a substrate. The first catalyst ink was coated on the substrate by a doctor blade and dried under atmosphere at 80° C. for five minutes. Then, the resultant “catalyst embedded in the polymer electrolyte” was collected from the substrate.

<Mixing the “Catalyst Embedded in a Polymer Electrolyte” with Carbon Particles and Heating>

The “catalyst embedded in the polymer electrolyte” and carbon particles (Ketjen Black, product code: EC-300J, made by Lion Corporation, specific surface area: 800 m²/g) were mixed together using a planetary ball mill without adding a solvent. A zirconia pot and zirconia balls were used for the ball mill. The composition ratio between the “catalyst embedded in the polymer electrolyte” and carbon particles was 1:1 by weight.

### <Preparing a Second Catalyst Ink>

The resultant mixture of the “catalyst embedded in the polymer electrolyte” and the carbon particles after heating was mixed with the 20% by weight solution of the polymer electrolyte in a second solvent followed by performing a dispersion treatment using a planetary ball mill. A zirconia pot and zirconia balls were used for the ball mill. The resultant second catalyst ink had a composition ratio of 1:1:0.8 among the catalyst, carbon particles and the polymer electrolyte. A solvent blend of ultrapure water and 1-propanol was used as the second solvent and their blend ratio was adjusted so as to have relative permittivity of about 55 at 20° C. In addition, the second catalyst ink had a solid content of 14% by weight.

### <Forming an Electrode Catalyst Layer>

A sheet of PTFE was used as a transfer sheet. The second catalyst ink was coated on the transfer sheet by a doctor blade and dried under atmosphere at 80° C. for five minutes. An electrode catalyst layer 2 for an air electrode was formed by adjusting the thickness in such a way that an amount of the catalyst which was loaded on the electrode catalyst layer in all was 0.4 mg/cm².

### Comparative Example 3

### <Preparing a First Catalyst Ink>

Carbon particles (Ketjen Black, product code: EC-300J, made by Lion Corporation, specific surface area: 800 m²/g) and a 20% by weight solution (solvent: IPA, ethanol and water) of a polymer electrolyte (Nafion®, made by DuPont) were mixed together in a first solvent followed by performing a dispersion treatment using a planetary ball mill (product code: P-7, by Fritsch Japan Co., Ltd). A zirconia pot and zirconia balls were used for the ball mill. The resultant first catalyst ink had a 1:0.5 by weight composition ratio between the carbon particles and the polymer electrolyte. Water was used as the first solvent, and had relative permittivity of about 80 at 20° C. In addition, the first catalyst ink had a solid content of 14% by weight.

### <Forming “Carbon Particles Embedded in a Polymer Electrolyte”>

The same substrate (PTFE) as is used in the Examples was used as a substrate. The first catalyst ink was coated on the substrate by a doctor blade and dried under atmosphere at 80° C. for five minutes. Then, the resultant “carbon particles embedded in the polymer electrolyte” were collected from the substrate.

<Mixing the “Carbon Particles Embedded in a Polymer Electrolyte” with a Catalyst and Heating>

The “carbon particles embedded in the polymer electrolyte” and a catalyst (TaCNO, specific surface area: 9 m²/g) were mixed together using a planetary ball mill without adding a solvent. A zirconia pot and zirconia balls were used for the ball mill. The composition ratio between the carbon particles and the catalyst was 1:1 by weight.

### <Preparing a Second Catalyst Ink>

The resultant mixture of the “carbon particles embedded in the polymer electrolyte” and the catalyst after the heating was mixed with the 20% by weight solution of the polymer electrolyte in a second solvent followed by performing a dispersion treatment using a planetary ball mill. A zirconia pot and zirconia balls were used for the ball mill. The resultant second catalyst ink had a composition ratio of 1:1:0.8 among the catalyst, carbon particles and the polymer electrolyte. A solvent blend of ultrapure toluene and 1-propanol was used as the second solvent and their blend ratio was adjusted so as to have relative permittivity of about 3 at 20° C. In addition, the second catalyst ink had a solid content of 14% by weight.

### <Forming an Electrode Catalyst Layer>

A sheet of PTFE was used as a transfer sheet. The second catalyst ink was coated on the transfer sheet by a doctor blade and dried under atmosphere at 80° C. for five minutes. An electrode catalyst layer 2 for an air electrode was formed by adjusting the thickness in such a way that an amount of the catalyst which was loaded on the electrode catalyst layer in all was 0.4 mg/cm².

### <<Forming an Electrode Catalyst Layer for a Fuel Electrode>>

An electrode catalyst layer for a fuel electrode is formed as described below in the Examples and Comparative examples. A catalyst of “platinum loaded carbon particles” (amount of loaded platinum: 50% by weight to the whole, product code: TEC10E50E, made by Tanaka Kikinzoku Kogyo K.K.) and a 20% by weight solution (solvent: IPA, ethanol and water) of a polymer electrolyte (Nafion®, made by DuPont) were mixed together in a solvent followed by performing a dispersion treatment using a planetary ball mill (product code: P-7, by Fritsch Japan Co., Ltd). The dispersion treatment was performed for 60 minutes. The resultant catalyst ink had a 1:1 by weight composition ratio between the carbons in the “platinum loaded carbon particles” and the polymer electrolyte. A solvent mixture of 1:1 by volume of ultrapure water and 1-propanol was used as the solvent. The resultant catalyst ink had a 10% by weight solid content. The catalyst ink was coated on a transfer sheet and dried in a similar way to the case of the electrode catalyst layer 2 for the air electrode. The electrode catalyst layer 3 for the fuel electrode was formed by adjusting the thickness in such a way that an amount of the catalyst which was loaded on the layer in all was 0.3 mg/cm².

### <<Fabricating an MEA>>

The transfer sheet on which the electrode catalyst layer 2 for the air electrode was formed described in the Examples 1-4 and Comparative examples 1-3 and the transfer sheet on which the electrode catalyst layer 3 for the fuel electrode was formed described above were respectively stamped out in a square shape of 5 cm² and arranged facing both surfaces of a polymer electrolyte membrane (Nafion®212, made by DuPont). Subsequently, hot pressing was performed at 130° C. for ten minutes to obtain an MEA 12. After arranging a pair of carbon papers having a filler layer as gas diffusion layers on both surfaces, the resultant MEA 12 was further interposed between a pair of separators 10 so that a single cell of PEMFC or PEFC was fabricated.

### <<Power Generation Performance>>

### <Measurement>

Power generation performance was measured under a condition of 80° C. cell temperature and 100% RH (relative humidity) both in an anode and cathode using a fuel cell test apparatus made by NF Corporation. Pure hydrogen as a fuel gas and pure oxygen as an oxidant gas were used and controlled to flow at a constant rate.

### <Result>

The MEA obtained in the Examples 1-4 had a power generation performance superior to the MEA obtained in the Comparative example 1. In particular, a power generation performance at around 0.6 V was improved in the Examples to such an extent that the MEA of Example 1 has about 2.5 times, the MEA of Example 2 has about 2.6 times, the MEA of Example 3 has about 1.9 times and the MEA of Example 4 has about 1.8 times higher performance than the MEA of Comparative example 1. It seems that this was because proton conductivity on a surface of the catalyst was improved and thereby increasing reaction sites as a result of embedding the catalyst in a polymer electrolyte in the MEAs of the Examples 1 and 3. In addition, it seems that proton conductivity on a surface of the catalyst was improved and thereby increasing reaction sites as a result of reducing a specific surface area of the carbon particles in the MEAs of the Examples 2 and 4. In contrast, it does not seem that proton conductivity on a surface of the catalyst was sufficiently improved in the Comparative example 1 because the polymer electrolyte was adsorbed to the carbon particles more dominantly than to the catalyst which had a less specific surface area since the catalyst and the carbon particles are dispersed in one step in the solvent together with the polymer electrolyte.

Although the MEAs of the Comparative examples 2 and 3 had a power generation performance superior to the MEA of the Comparative example 1, the power generation performance was not improved to a level comparable to the MEAs of the Examples 1-4. The power generation performance was only about 1.2 times higher in the Comparative example 2 and 1.1 times higher in the Comparative example 3 than in the Comparative example 1. It seems that this was because the proton conductivity on a surface of the catalyst was improved to only an insufficient level since the first solvent did not have relative permittivity 1.2 or more times higher than that of the second solvent and thus the polymer electrolyte in which the catalyst was embedded was partially dissolved into the second solvent when preparing the second catalyst ink in the Comparative example 2. In addition, it seems that the power generation performance was improved only to an insufficient level in the MEA of the Comparative example 3 because the relative permittivity of the first solvent is more than 25 times higher that of the second solvent and thereby inhibiting formation of the electrode catalyst layer.

### SUMMARY

The manufacturing method of an MEA of the present invention makes it possible to provide an MEA or a PEMFC having a high level of output performance in which active reaction sites are increased in the electrode catalyst layer which includes a polymer electrolyte, a catalyst and carbon particles by embedding the catalyst, which has a smaller specific surface area than the carbon particles, in the polymer electrolyte and thereby improving proton conductivity on a surface of the catalyst. In the present invention, it is possible to uniformly embed the catalyst in the polymer electrolyte by selecting a first solvent in a first catalyst ink and a second solvent in a second catalyst ink in such a way that the second solvent has smaller relative permittivity than the first solvent. Then, it also becomes difficult for the polymer electrolyte in which the catalyst is embedded to dissolve into the second solvent.

In addition, another aspect of the present invention includes a process of embedding the carbon particles which have a larger specific surface area than the catalyst in a polymer electrolyte, and thereby reducing the specific surface area of the carbon particles. In forming an electrode catalyst layer, it is possible to improve proton conductivity on a surface of the catalyst by controlling and reducing the specific surface area of the carbon particles. As a result, active reaction sites are increased, and the manufacturing method of an MEA of the present invention makes it possible to provide a PEMFC, an MEA and an electrode catalyst layer which have a high level of output performance. In the present invention, it is possible to uniformly embed the carbon particles in the polymer electrolyte by selecting a first solvent in a first catalyst ink and a second solvent in a second catalyst ink in such a way that the second solvent has smaller relative permittivity than the first solvent. Then, it also becomes difficult for the polymer electrolyte in which the carbon particles are embedded to dissolve into the second solvent.

The present invention relates to a manufacturing method of an electrode catalyst layer containing a polymer electrolyte, a catalyst and carbon particles. And the present invention has a feature of including a process of preliminarily embedding the catalyst in the polymer electrolyte. As a result, it is possible to improve proton conductivity on a surface of the catalyst and to increase active reaction sites so that a PEMFC with a high level of output performance is provided. Alternatively, the present invention has a feature of including a process of preliminarily embedding the carbon particles in the polymer electrolyte. As a result, a specific surface area of the carbon particles is preliminarily reduced, which makes it possible to improve proton conductivity on a surface of the catalyst during formation of the electrode catalyst layer to increase active reaction sites, so that a PEMFC and an MEA with a high level of output performance are obtained.

The present invention is highly useful in industry because of a remarkable effect that a catalyst in the electrode catalyst layer achieves a performance higher than in the case of a conventional method, especially in the case where an oxide of non-platinum is used as the catalyst.

What is claimed is:

1. A manufacturing method of an electrode catalyst layer, said electrode catalyst layer comprising:
a first polymer electrolyte;
a second polymer electrolyte;
a catalyst; and
carbon particles, said method comprising:
a process 1 of preparing a first catalyst ink in which said catalyst and said first polymer electrolyte are dispersed in a first solvent;
a process 2 of drying said first catalyst ink to obtain a catalyst embedded in said first polymer electrolyte;
a process 3 of preparing a second catalyst ink in which said catalyst embedded in said first polymer electrolyte, said second polymer electrolyte, and said carbon particles are dispersed in a second solvent; and
a process 4 of coating said second catalyst ink on a substrate and drying said second catalyst ink to form an electrode catalyst layer, wherein
said substrate is any one selected from the group consisting of a gas diffusion layer, a transfer sheet, and a polymer electrolyte membrane, and wherein
a ratio of relative permittivity between said first solvent and said second solvent is in the range of 1.2:1 to 25:1 at 20° C.

2. The manufacturing method of an electrode catalyst layer according to claim 1, wherein, in said catalyst embedded in said first polymer electrolyte in said process 2, a ratio between said catalyst and said first polymer electrolyte is the range of 1:0.01 to 1:30 by weight.

3. The manufacturing method of an electrode catalyst layer according to claim 2, wherein, before performing said process 3, said carbon particles and said catalyst embedded in said first polymer electrolyte are preliminarily mixed together without adding any solvent.

4. The manufacturing method of an electrode catalyst layer according to claim 3, wherein said catalyst is a positive electrode active material and contains at least one transition metal selected from the group consisting of Ta, Nb, Tl and Zr.

5. The manufacturing method of an electrode catalyst layer according to claim 4, wherein said catalyst is a product obtained by partially-oxidizing a carbonitride of said transition metal in an atmosphere including oxygen.

6. The manufacturing method of an electrode catalyst layer according to claim 5, wherein said transition metal is Ta.

7. A manufacturing method of an electrode catalyst layer, said electrode catalyst layer comprising:
a first polymer electrolyte;
a second polymer electrolyte;
a catalyst; and
carbon particles, said method comprising:
a process 1 of preparing a first catalyst ink in which said carbon particles and said first polymer electrolyte are dispersed in a first solvent;
a process 2 of drying said first catalyst ink to obtain carbon particles embedded in said first polymer electrolyte;
a process 3 of preparing a second catalyst ink in which said carbon particles embedded in said first polymer electrolyte, said second polymer electrolyte, and said catalyst are dispersed in a second solvent; and
a process 4 of coating said second catalyst ink on a substrate and drying said second catalyst ink to form an electrode catalyst layer, wherein
said substrate is any one selected from the group consisting of a gas diffusion layer, a transfer sheet, and a polymer electrolyte membrane, and wherein
a ratio of relative permittivity between said first solvent and said second solvent is in the range of 1.2:1 to 25:1 at 20° C.

8. The manufacturing method of an electrode catalyst layer according to claim 7, wherein, in said carbon particles embedded in said first polymer electrolyte in said process 2, a ratio between said carbon particles and said first polymer electrolyte is the range of 1:0.1 to 1:20 by weight.

9. The manufacturing method of an electrode catalyst layer according to claim 8, wherein, before performing said process 3, said catalyst and said carbon particles embedded in first polymer electrolyte are preliminarily mixed together without adding any solvent.

10. The manufacturing method of an electrode catalyst layer according to claim 9, wherein said catalyst is a positive electrode active material and contains at least one transition metal selected from the group consisting of Ta, Nb, Tl and Zr.

11. The manufacturing method of an electrode catalyst layer according to claim 10, wherein said catalyst is a product obtained by partially-oxidizing a carbonitride of said transition metal in an atmosphere including oxygen.

12. The manufacturing method of an electrode catalyst layer according to claim 11, wherein said transition metal is Ta.
